(19) United States
(12) Patent Application Publication
(10) Pub. No.: US 2009/0097486 A1
(43) Pub. Date: Apr. 16, 2009

(54) Common Checksum Computation for Internet Protocol Version 4 and Version 6 Transmissions

(75) Inventors: Antonio R. Carlini, Oxfordshire (GB); Andrew S. Chittenden, Berkshire (GB); Jonathan M. Smith, Berkshire (GB)

Correspondence Address: BROMBERG & SUNSTEIN LLP, 125 SUMMER STREET, BOSTON, MA, 02110-1618, US

(73) Assignee: BLUEARC UK LIMITED, Bracknell (GB)

(21) Appl. No.: 11/871,379

(22) Filed: Oct. 12, 2007

(51) Int. Cl. H04L 12/28

(52) U.S. Cl. 370/392

(57) ABSTRACT

Checksums for internet protocol transmissions of certain transport layer messages are generated using IPv6 pseudo-headers for both IPv4 and IPv6 internet protocol transmissions. For IPv4 transmissions, IPv4 information is mapped into an IPv6 pseudo-header, and the checksum is computed using the IPv6 pseudo-header. Among other things, embodiments of the present invention allow checksums for both IPv4 and IPv6 internet protocol transmissions such transport layer messages to be computed using a common checksum computer.

### FIELD OF THE INVENTION

The present invention relates generally to computing checksums, and more particularly, to a method of computing checksums for IPv4 and IPv6 transmissions.

### BACKGROUND OF THE INVENTION

In today's information age, computers and other types of communication devices are often interconnected over communication networks. Examples of communications networks include private and public local area networks, metropolitan area networks, wide area networks, and intranets. Perhaps the most well-known and widely used communication network is the Internet.

FIG. 1 shows a representation of a communication system as known in the art. Here, a source communication device is in communication with a destination communication device over the Internet 120. The Internet is based on a suite of protocols known as TCP/IP, which is promulgated by the Internet Engineering Task Force (“IETF”). The protocols in the TCP/IP suite are generally defined in terms of a hierarchy (stack) having various protocol layers, where each layer uses communication services provided by the protocol layer immediately below it in the stack and provides communication services to the protocol layer immediately above it in the stack.

The Internet Protocol (“IP”), part of the TCP/IP suite of protocols, is a network layer protocol used in the Internet. IP messages (often referred to as “datagrams”) are routed through the network based on source and destination IP addresses. Because there is no concept of an end-to-end connection at the IP layer, and because IP does not include mechanisms for ensuring delivery of IP datagrams to the destination, IP datagrams may be dropped by the communication network or routed over different paths so as to arrive at the destination out-of-order. Thus, IP is considered to be a connectionless, unreliable protocol.

Today, there are two commonly-used versions of IP, namely IP version 4 (“IPv4”) and IP version 6 (“IPv6”). IPv4 is described in IETF RFC 791, which is hereby incorporated herein by reference in its entirety. IPv6 is described in IETF RFC 2460, which is hereby incorporated herein by reference in its entirety. The main purpose of both versions is to provide unique global computer addressing to ensure that communicating devices can identify one another. One of the main distinctions between IPv4 and IPv6 is that IPv4 uses 32-bit addresses, whereas IPv6 utilizes 128 bit addresses. In addition, IPv6 can support larger datagram sizes.

IP datagrams are often used to encapsulate and carry messages from higher layer protocols. In the TCP/IP suite of protocols, the layer above the IP layer is referred to as the transport layer. Two commonly-used transport layer protocols are the User Datagram Protocol (“UDP”) and the Transmission Control Protocol (“TCP”). UDP is described in IETF RFC 768, which is hereby incorporated herein by reference in its entirety. TCP is described in IETF RFC 793, which is hereby incorporated herein by reference in its entirety. Transport layer messages (often referred to as “segments”) are essentially used to carry information from a particular application in the source to the corresponding application in the destination, whereas the IP datagram itself is essentially used as an envelope to carry the UDP or TCP segment from the source to the destination.

Although both UDP and TCP are used to convey information at the transport layer, they operate in different ways. In particular, UDP is a relatively simple protocol that does not include mechanisms for establishing end-to-end connections and retransmitting segments that may be dropped or received out-of-order. Time sensitive applications, such as streaming media, Voice over IP (VoIP), and online games, typically use UDP because it is faster than TCP. In contrast to UDP, TCP is connection-oriented and includes mechanisms for retransmitting segments that may be dropped or received out-of-order. Thus, TCP is a more reliable protocol than UDP. Applications such as e-mail and file transfer protocol typically utilize TCP in order to take advantage of the connection-oriented, reliable nature of TCP.

Although the UDP and TCP protocols have different approaches to sending information, UDP and TCP segments have the following general format:

Segment Header
Segment Data

Despite the common general format, however, the information contained within the UDP and TCP headers differs. The following is a representation of the format of the UDP header:

| + | Bits 0-15 | 16-31 |
|---|---|---|
| 0 | Source Port | Destination Port |
| 32 | Length | Checksum |

As shown above, the UDP header includes a 16-bit source port field, a 16-bit destination port field, a 16-bit length field, and a 16-bit checksum field.

The following is a representation of the format of the TCP header:

| | | | | |
|---|---|---|---|---|
| + | Bits 0-3 | 4-9 | 10-15 | 16-31 |

| | | |
|---|---|---|
| 0 | Source Port | Destination Port |

| | |
|---|---|
| 32 | Sequence Number |
| 64 | Acknowledgment Number |

| | | | | |
|---|---|---|---|---|
| 96 | Data | Reserved | Control | Window |
| | Offset | | Bits | |

| | | |
|---|---|---|
| 128 | Checksum | Urgent Pointer |

| | |
|---|---|
| 160 | Options |

As shown above, the TCP header includes a 16-bit source port field, a 16-bit destination port field, a 32-bit sequence number field, a 32-bit acknowledgement number field, a 4-bit data offset field, a 6-bit reserved field, a 6-bit control bits field, a 16-bit window field, a 16-bit checksum field, a 16-bit urgent pointer field, and an optional variable-length options field that is padded with zeros as necessary to make the options field an integer multiple of 32-bits.

As illustrated above, both the UDP header and the TCP header include a 16-bit checksum field. The source computes a checksum for the segment and inserts the checksum into the segment header prior to transmission. Upon receipt of the segment, the destination computes a checksum for the received segment and compares it with the checksum in the segment header in order to determine whether the segment was received correctly or in error.

In both the source and the destination, the checksum is computed using a pseudo-header that is logically appended to the segment. The checksum is computed over predetermined fields in the pseudo-header, the segment header, and the segment data. Conceptually, the segment will look as follows once the pseudo-header is appended:

Pseudo-Header
Segment Header
Segment Data

While the pseudo-headers are the same for both UDP and TCP, different pseudo-header formats are used for IPv4 and IPv6 transmissions. The following is a representation of the format of the IPv4 pseudo-header:

| | | | | |
|---|---|---|---|---|
| + | Bits 0-7 | 8-15 | 16-23 | 24-31 |

| 0 | Source Address | | |
|---|---|---|---|
| 32 | Destination Address | | |
| 64 | Zero | Protocol | Length |

The values that are placed in the IPv4 pseudo-header field are well-defined. In summary, the IPv4 pseudo-header includes a 32-bit source address field that is set to the IPv4 source address, a 32-bit destination address field that is set to the IPv4 destination address, an 8-bit zero field, an 8-bit protocol field that specifies the transport layer protocol, and a 16-bit length field.

The following is a representation of the format of the IPv6 pseudo-header:

| | | | | |
|---|---|---|---|---|
| + | Bits 0-7 | 8-15 | 16-23 | 24-31 |

| | |
|---|---|
| 0 | Source Address |
| 128 | Destination Address |
| 256 | Upper-Layer Packet Length |

| | | |
|---|---|---|
| 288 | Zero | Next Header |

The values that are placed in the IPv6 pseudo-header fields are well-defined. In summary, the IPv6 pseudo-header includes a 128-bit source address field that is set to the IPv6 source address, a 128-bit destination address field that is set to the IPv6 destination address, a 32-bit upper-layer packet length field, a 24-bit zero field, and an 8-bit next header field.

The checksum is computed generally as follows. The fields of the pseudo-header and the segment header are populated with information in accordance with the appropriate standards. The data field of the segment is logically padded with zeros as necessary to produce a data field that is an integer multiple of 16 bits (for IPv4) or 32 bits (for IPv6). The checksum field of the segment header is treated as being zero for checksum computation purposes. The checksum is computed as the one's complement of the one's complement sum of all 16-bit words in the pseudo-header, the segment header, and the data field (including any padding).

The source computer inserts the computed checksum into the segment header, and the segment (including the segment header with checksum and the data excluding any padding) is included in the IP datagram for transmission to the destination computer. The pseudo-header is not transmitted.

Both the source computer and the destination computer may have distinct IPv4 and IPv6 logic that handles, among other things, the IP layer functionality as well as the IP-dependent transport layer functionality (e.g., the UDP/TCP pseudo-headers and checksum functionality) associated with the specific IP version. Thus, for example, the source computer may include IPv4 logic that implements the IPv4 transport layer checksum functionality including use of IPv4 pseudo-headers and IPv6 logic that implements the IPv6 transport layer checksum functionality including use of IPv6 pseudo-headers. Similarly, the destination computer may include IPv4 logic that implements the IPv4 transport layer checksum functionality including use of IPv4 pseudo-headers and IPv6 logic that implements the IPv6 transport layer checksum functionality including use of IPv6 pseudo-headers.

### SUMMARY OF THE INVENTION

In accordance with one aspect of the invention there is provided a method of computing checksums for internet protocol transmissions of transport layer messages. The method involves generating an IPv6 pseudo-header for an IPv4 internet protocol transmission of a transport layer message; computing a checksum for such transport layer message using the IPv6 pseudo-header; and storing the computed checksum in a memory for at least one of transmission of transport layer messages and validation of the transport layer messages.

In accordance with another aspect of the invention there is provided apparatus for computing checksums for internet protocol transmissions of transport layer messages. The apparatus includes a pseudo-header generator configured to generate IPv6 pseudo-headers for IPv4 internet protocol transmissions of transport layer messages and a checksum computer in communication with the pseudo-header generator and configured to compute checksums for such transport layer messages using the IPv6 pseudo-headers for at least one of transmission of transport layer messages and validation of transport layer messages.

In accordance with another aspect of the invention there is provided apparatus for computing checksums for internet protocol transmissions of transport layer messages. The apparatus includes an IPv4 processor for processing IPv4 internet protocol transmissions, the IPv4 processor configured to generate IPv6 pseudo-headers for IPv4 internet protocol transmissions of transport layer messages; an IPv6 processor for processing IPv6 internet protocol transmissions, the IPv6 processor configured to generate IPv6 pseudo-headers for IPv6 internet protocol transmissions of transport layer messages; and a checksum computer in communication with the IPv4 processor and the IPv6 processor and configured to compute checksums for both IPv4 and IPv6 internet protocol transmissions of transport layer messages using IPv6 pseudo-headers for at least one of transmission of transport layer messages and validation of transport layer messages.

In various embodiments, transport layer messages may include UDP messages and/TCP messages, although the present invention is not necessarily limited to UDP and TCP. In particular, embodiments of the present invention may apply to other transport layer protocols for which the specified value for the protocol field of the IPv4 pseudo-header matches the specified value for the next header field of the IPv6 pseudo-header.

In various embodiments, IPv4 information is mapped into the IPv6 pseudo-header in such a way that the checksum computed using the IPv6 pseudo-header would match a checksum that would have resulted from use of an IPv4 pseudo-header. For example, mapping may include converting a 32-bit IPv4 source address into a 128-bit source address for the IPv6 pseudo-header; converting a 32-bit IPv4 destination address into a 128-bit destination address for the IPv6 pseudo-header; converting a 16-bit IPv4 length into a 32-bit length for the IPv6 pseudo-header; and mapping an IPv4 protocol into a next header for the IPv6 pseudo-header. Converting a 32-bit IPv4 address into a 128-bit address may involve appending a sequence of 0x00000000000000000000FFFF ahead of the 32-bit IPv4 address to result in a 128-bit address represented by 0x00000000000000000000FFFFXXXXXXXX, where “XXXXXXXX” represents the 32-bit IPv4 address. Converting a 16-bit length into a 32-bit length may involve appending a sequence of 0x0000 ahead of the 16-bit IPv4 length to result in a 32-bit length represented by 0x0000XXXX, where “XXXX” represents the 16-bit IPv4 length.

For transmission of transport layer messages, the computed checksum may be stored in a header of the transport layer message or in another appropriate location. For validating received transport layer messages, the computed checksum may be compared with a received checksum for the received transport layer message. In any case, the computed checksum may be stored at least temporarily in a memory, such as a RAM, a hardware register, or other storage. Embodiments of the present invention may be implemented in software, in hardware (e.g., discrete components, ASICs, FPGAs, etc.), or using a combination of hardware and software. Embodiments of the present invention may apply to any device that transmits and/or receives IP transmissions of transport layer messages such as, for example, computers, file servers, etc.

### BRIEF DESCRIPTION OF THE DRAWINGS

The foregoing and advantages of the invention will be appreciated more fully from the following further description thereof with reference to the accompanying drawings wherein:

FIG. 1 schematically shows communications devices communicating over the a communication network such as the Internet;

FIG. 2 schematically shows a representation of how IPv4 pseudo-header information is mapped into an IPv6 pseudo-header in accordance with embodiments of the present invention;

FIG. 3 is a logic flow diagram showing exemplary logic for transmitting IPv4 and IPv6 transmissions in accordance with embodiments of this invention;

FIG. 4 is a logic flow diagram showing exemplary logic for processing received IPv4 and IPv6 transmissions in accordance with embodiments of this invention;

FIG. 5A is a block diagram showing the architecture of a system for transmitting IPv4 and IPv6 transmissions in accordance with one embodiment of the present invention;

FIG. 5B is a block diagram showing the architecture of a system for transmitting IPv4 and IPv6 transmissions in accordance with another embodiment of the present invention;

FIG. 6A is a block diagram showing the architecture of a system for processing received IPv4 and IPv6 transmissions in accordance with one embodiment of the present invention; and

FIG. 6B is a block diagram showing the architecture of a system for processing received IPv4 and IPv6 transmissions in accordance with one embodiment of the present invention.

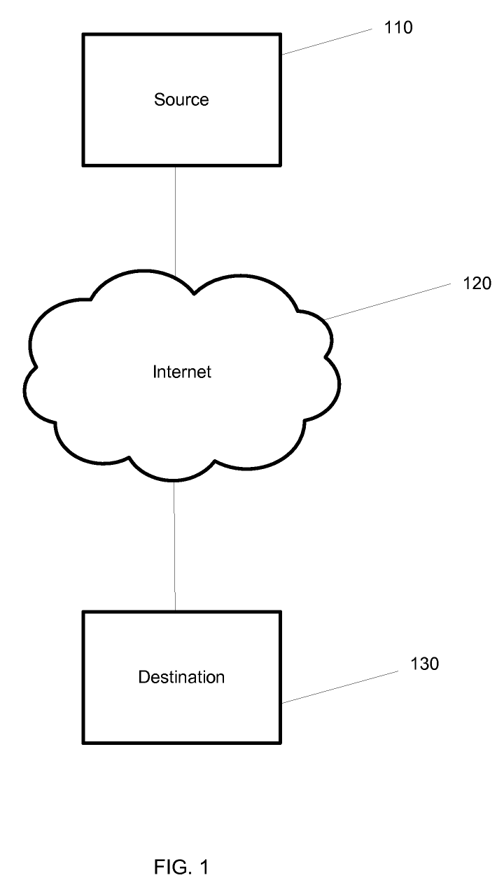

It should be noted that the foregoing figures and the elements depicted therein are not necessarily drawn to consistent scale or to any scale. Unless the context otherwise suggests, like elements are indicated by like numerals.

### DETAILED DESCRIPTION OF SPECIFIC EMBODIMENTS

The above-named inventors have discovered and confirmed through testing that the IPv6 pseudo-header can be used for computing UDP and TCP checksums for both IPv4 and IPv6 transmissions. Thus, for example, the source device can use the IPv6 pseudo-header to compute UDP and TCP checksums regardless of whether the IP datagram is to be transmitted using IPv4 or IPv6 and regardless of whether the destination will compute the checksum using the IPv4 pseudo-header or the IPv6 pseudo-header. Similarly, the destination device can use the IPv6 pseudo-header to compute UDP and TCP checksums regardless of whether the IP datagram was received using IPv4 or IPv6 and regardless of whether the source computed the checksum using the IPv4 pseudo-header or the IPv6 pseudo-header.

In embodiments of the present invention, in order to compute the UDP or TCP checksums for IPv4 transmissions, the information that would have been placed into the IPv4 pseudo-header is mapped into the IPv6 pseudo-header in a way that ensures that the resulting UDP or TCP checksum will match the checksum that would have resulted from use of the IPv4 pseudo-header; this mapping is described in detail below. By using the same pseudo-header for both IPv4 and IPv6 transmissions, common checksum computation logic can be used for both IPv4 and IPv6 transmissions in the source and/or the destination. One advantage of having common checksum computation logic is that it uses less memory and other resources, which is particularly advantageous for implementations of the checksum computation logic in hardware (e.g., discrete hardware, programmable logic such as FPGAs, or integrated circuitry).

As mentioned above, embodiments of the present invention utilize a mapping process to generate an IPv6 pseudo-header for an IPv4 transmission. The mapping process is required because the data fields and/or data sizes within the IPv4 pseudo-header do not necessarily correspond to those of the IPv6 pseudo-header. Therefore, the mapping process essentially converts the data fields and data sizes of the information for the IPv4 pseudo-header into fields and sizes (e.g., lengths) that correspond to the IPv6 pseudo-header.

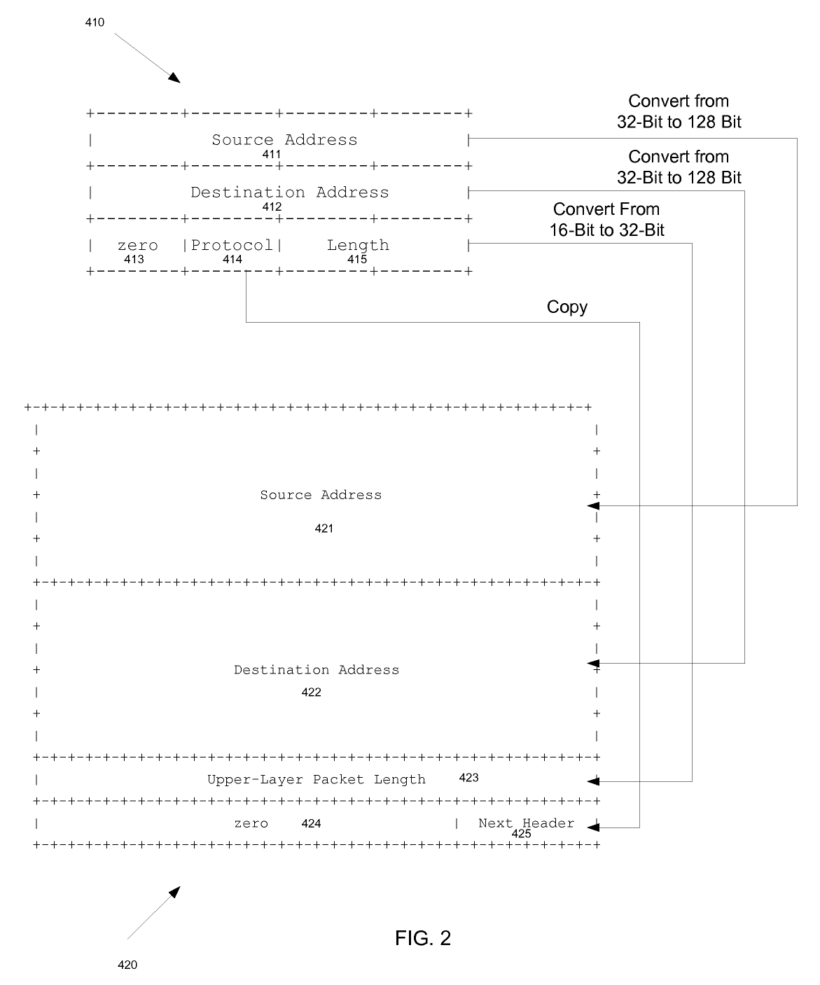

FIG. 2 shows a representation of the mapping of IPv4 pseudo-header information into the IPv6 pseudo-header in accordance with an exemplary embodiment of the present invention. As shown in FIG. 2, both the IPv4 pseudo-header 410 and the IPv6 pseudo-header 420 include a source address field and a destination address field. However, the IPv4 source address field 411 is 32 bits while the IPv6 source address field 421 is 128 bits, and the IPv4 destination address field 412 is 32 bits while the IPv6 destination address field 422 is 128 bits. Therefore, the 32-bit IPv4 source address is converted into a 128-bit address and stored in the IPv6 source address field 421, and the 32-bit IPv4 destination address is converted into a 128-bit address and stored in the IPv6 destination address field 422. The address conversion is done in such a way as to ensure that the resulting UDP or TCP checksum will match the checksum that would have resulted from use of the IPv4 pseudo-header.

In an exemplary embodiment of the present invention, a 32-bit IPv4 address is converted into a 128-bit address by appending a predetermined sequence to the 32-bit IPv4 address to create a 128-bit address. For example, if the 32-bit IPv4 address is represented by 0xXXXXXXXX (where “0x” indicates a hexadecimal representation), then the 32-bit IPv4 address may be converted into a 128-bit address by appending the sequence 0x00000000000000000000FFFF ahead of the 32-bit address to result in a 128-bit address represented by 0x00000000000000000000FFFFXXXXXXXX. It important to note that, because of the way the checksum is computed, the appended value has no effect on the checksum. It should also be noted that other sequences (e.g., all zeros, all ones) and/or other conversion schemes (e.g., appending the sequence after the IPv4 address) may be employed in alternative embodiments.

Like the source and destination addresses described above, both the IPv4 pseudo-header 410 and the IPv6 pseudo-header 420 include a length field. However, the IPv4 length field 415 is 16 bits, while the IPv6 length field is 32 bits. Therefore, in order to map the 16-bit IPv4 length into corresponding field in the IPv6 pseudo-header (e.g., the upper-layer packet length 423). Therefore, the 16-bit IPv4 length is converted into a 32-bit length and stored in the IPv6 upper-layer packet length field 423. The length conversion is done in such a way as to ensure that the resulting UDP or TCP checksum will match the checksum that would have resulted from use of the IPv4 pseudo-header.

In an exemplary embodiment of the present invention, the 16-bit IPv4 length is converted into a 32-bit length by appending a sequence of zeros to the IPv4 length. For example, if the 16-bit IPv4 length is represented by 0xXXXX, then the 16-bit IPv4 length may be converted into a 32-bit length by appending the sequence 0x0000 ahead of the 16-bit length to result in a 32-bit length represented by 0x0000XXXX. It important to note that, because of the way the checksum is computed, the appended value has no effect on the checksum. It should also be noted that other sequences (e.g., all ones) and/or other conversion schemes (e.g., appending the sequence after the IPv4 length) may be employed in alternative embodiments.

As shown in FIG. 2, the remaining fields (other than the zero fields 413 and 424) within the IPv4 and IPv6 pseudo-headers 410 and 420 do not match. In particular, the IPv4 pseudo-header 410 contains a protocol field 414 situated in the third longword, while the IPv6 pseudo-header contains a next header field 425 situated in a different position within the tenth longword. The functions of the protocol field 414 and the next header field 425 are different, and the lists of values defined for those fields in the respective standards are different. However, the above-named inventors have discovered that, for the UDP and TCP protocols (and perhaps additional protocols), the value to be placed in the IPv6 next header field 425 is the same as the value to be placed in the IPv4 protocol field 414. Therefore, the IPv4 protocol value can simply be copied to the IPv6 next header field 425. Because both the IPv4 protocol field 414 and the IPv6 next header field 425 are 8-bit fields that are adjacent to zero fields, no further conversion is required.

Although FIG. 2 depicts the mapping of IPv4 fields into IPv6 fields described above, such depiction is included only for convenience in order to show the differences between the IPv4 and IPv6 pseudo-headers and the manner in which information is mapped into the IPv6 pseudo-header, and it should be noted the mapping of IPv4 information into the IPv6 pseudo-header is typically done without the intermediate steps of creating an IPv4 pseudo-header and mapping the information from the IPv4 pseudo-header into the IPv6 pseudo-header.

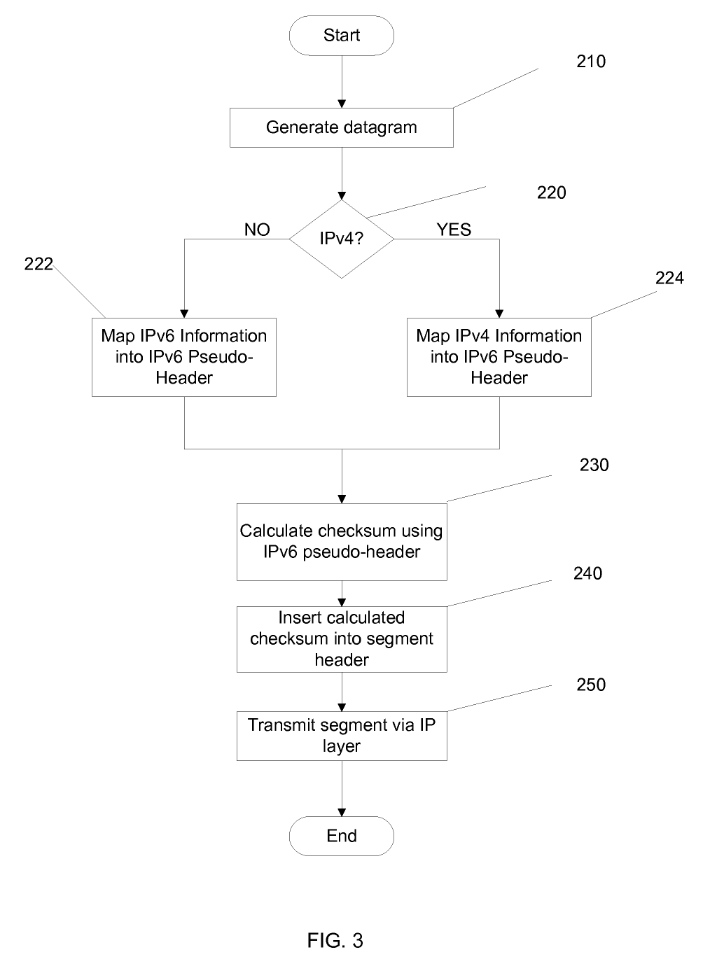

As discussed above, embodiments of the present invention may allow the source device 110 to use common logic to compute the UDP or TCP checksum using an IPv6 pseudo-header for both IPv4 and IPv6 transmissions. FIG. 3 schematically shows the general logic that a sending device 110 may utilize in accordance with embodiments of this invention. As shown in FIG. 3, the sending device 110 first generates the UDP or TCP segment in block 210. As discussed above, the segment will include a segment header and the data to be transmitted. The sending device 110 then determines whether the segment will be sent using IPv4 or IPv6, in block 220. If the segment will be sent using IPv4 (YES in block 220), then the sending device 110 maps the IPv4 information into an IPv6 pseudo-header, in block 224; otherwise (NO in block 220), the sending device 110 maps IPv6 information into the IPv6 pseudo-header as usual, in block 222. Once the IPv6 pseudo-header is generated, the sending device 110 calculates the checksum for the segment using the IPv6 pseudo-header, in block 230, and inserts the checksum into the segment header, in block 240. Once the segment is completed, it can then be transmitted by the IP layer, in block 250. It is important to note that, in this example, the sending device 110 uses separate logic paths (i.e., blocks 222 and 224 in FIG. 3) to set up the IPv6 pseudo-header for the IPv4 and IPv6 cases, but thereafter may use common logic to calculate the checksum, insert the checksum into the segment header, and transmit the segment.

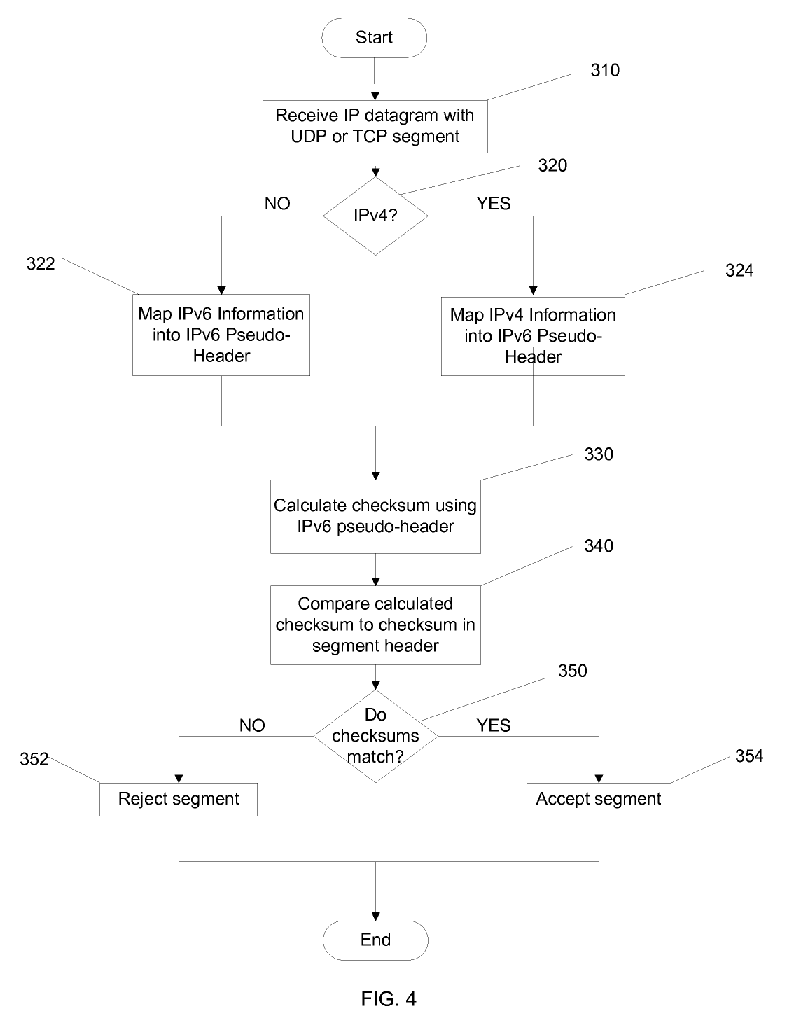

Similarly, embodiments of the present invention may allow the destination device 130 to use common logic to compute the UDP or TCP checksum using an IPv6 pseudo-header for both IPv4 and IPv6 transmissions. FIG. 4 schematically shows the general logic utilized by destination device 130 in accordance with embodiments of the present invention. As shown in FIG. 4, upon receipt of an IP datagram containing a UDP or TCP segment, in block 310, the destination device 130 determines whether the transmission is IPv4 or IPv6, in block 320. If IPv4 (YES in block 320), then the destination device 130 maps IPv4 information into an IPv6 pseudo-header, in block 324; otherwise (NO in block 320), the destination device 130 maps IPv6 information into the IPv6 pseudo-header as usual, in block 322. Once the IPv6 pseudo-header is generated, the destination device 130 calculates a checksum for the UDP or TCP segment using the IPv6 pseudo-header, in block 330, and compared the calculated checksum with the checksum received in the segment header, in block 340. If the checksums match (YES in block 350), then the segment is accepted for further processing (block 354); otherwise (NO in block 350), the segment is rejected (block 352). It is important to note that, in this example, the destination device 130 uses separate logic paths (i.e., blocks 322 and 324 in FIG. 4) to set up the IPv6 pseudo-header for the IPv4 and IPv6 cases, but thereafter may use common logic to calculate the checksum, compare the calculated checksum to the received checksum, and perform additional processing.

As discussed above, among other things, the use of the IPv6 pseudo-header for both IPv4 and IPv6 transmissions allows communication devices to employ common logic for checksum computation and other functions, which is particularly advantageous for hardware-based implementations.

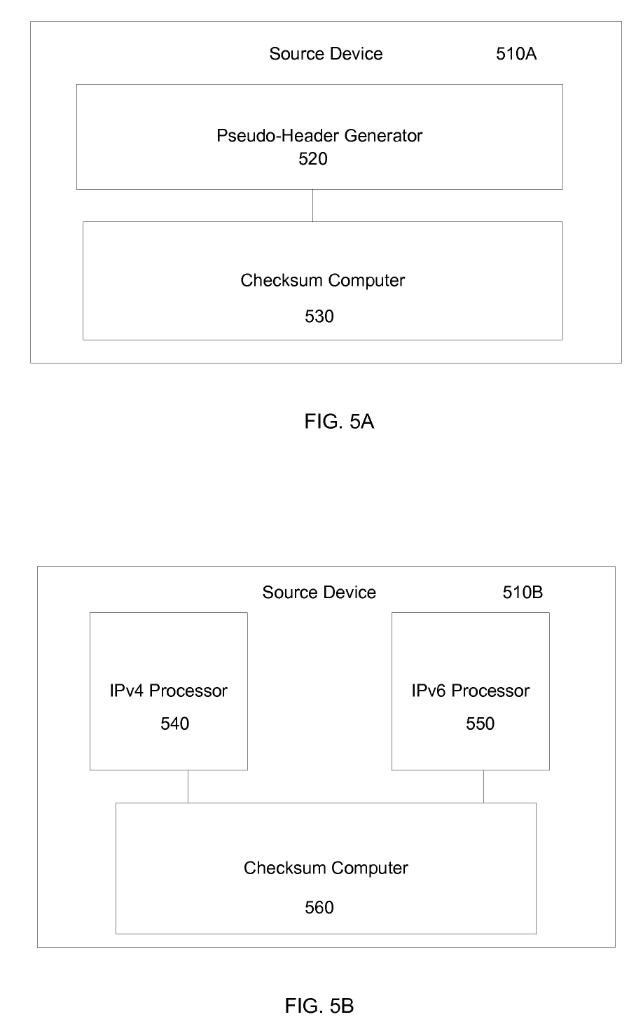

In particular, as shown in FIG. 5A, the source device 510A may include a pseudo-header generator 520 and a checksum computer 530. The pseudo-header generator 520 maps and generates the pseudo-header for the outgoing segment. Regardless of whether the IP transmission is IPv4 of IPv6, the pseudo-head generator 520 generates an IPv6 pseudo-header, as described above. Once the IPv6 pseudo-header is generated, the checksum computer 530 computes a checksum for the segment based on the IPv6 pseudo-header. The checksum computer 530 then inserts the checksum value into the appropriate field in the segment header. Although the pseudo-header generator 520 includes separate logic for IPv4 and IPv6 transmissions (e.g., one for mapping IPv4 information into an IPv6 pseudo-header and another for mapping IPv6 information into a IPv6 pseudo-header), the checksum computer 530 may use a common logic implementation to calculate the checksum for either a IPv4 or an IPv6 transmission because the checksum is based on the IPv6 pseudo-header for both types of transmissions.

Unlike the above described hardware embodiment, alternative embodiments may utilize one or more processors. For example, as shown in FIG. 5B, some embodiments may utilize an IPv4 processor 540 and an IPv6 processor 550. In a manner similar to that described above for the pseudo-header generator 520, the IPv4 and IPv6 processors 540/550 generate the pseudo-headers for checksum computation. In particular, the IPv6 processor 550 contains logic for generating an IPv6 pseudo-header for any outgoing IPv6 protocol transmissions, while the IPv4 processor 540 contains logic for mapping and generating an IPv6 pseudo-header for IPv4 transmissions. A single checksum computer 560 can then compute the checksums using the IPv6 pseudo-headers and insert the value into the UDP or TCP segment header.

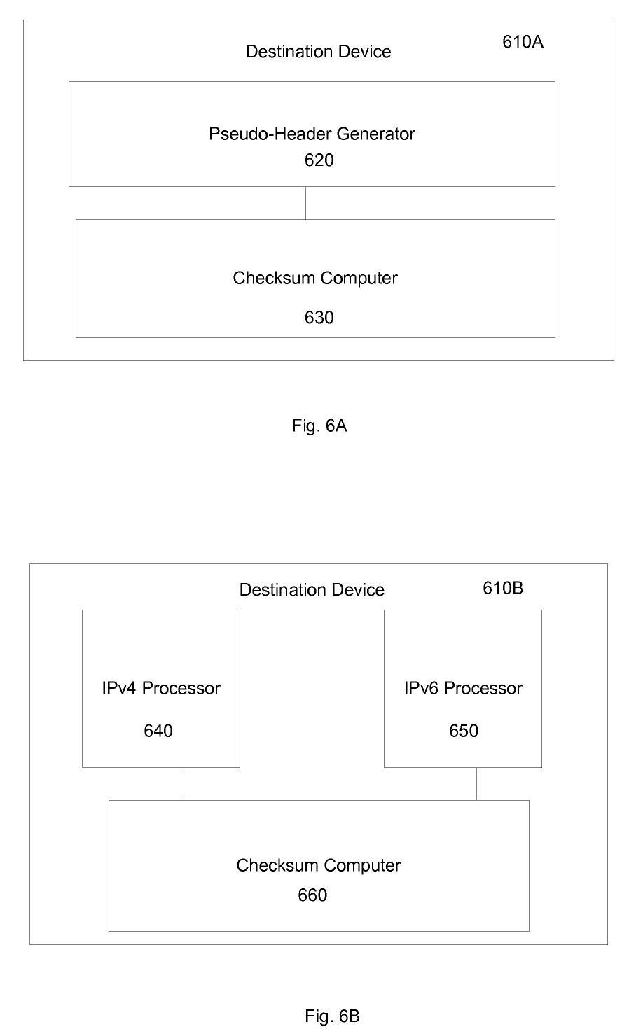

In a similar manner to that described above with respect to the source device 510, the destination device can also benefit from common code and reduced number of components. For instance, the destination device 610 may include a pseudo-header generator 620 and a checksum computer 630, as shown in FIG. 6A, or may include separate IPv4 and IPv6 processors 640/650 and a checksum computer 660, as shown in FIG. 6B. Like their counterparts in the source device 510, the pseudo-head generator 620 and the IPv4 and IPv6 processors 640/650 have first logic for mapping and generating an IPv6 pseudo-header for an IPv6 transmission and second logic for mapping and generating an IPv6 header for an IPv4 transmission, and the checksum computers 630/660 may include common logic for calculating checksums based on the IPv6 pseudo-headers.

In practice, the computed checksums are typically stored at least temporarily in a memory (e.g., a RAM, a hardware register, or other storage), e.g., for transmission of transport layer messages or validation of transport layer messages. Thus, for example, a computed checksum may be stored in a segment header of a transport layer message within a memory or may be stored in a register for comparison with a received checksum.

It is important to note that, although the above described embodiments are described in relation to UDP and TCP data transmissions, some embodiments may be used to compute checksums for other protocols carried in IP datagrams, in particular protocols for which the IPv4 “protocol” and IPv6 “next header” values are the same.

It is also important to note that although FIGS. 3 and 4 set out a series of steps that a source or destination device may follow, some embodiments and applications of the present invention may include additional steps not shown. For example, after receiving a transmission, the destination device may perform some IP layer processing including, but not limited to, determining whether the received transmission was meant for the receiving device or establishing a connection prior to sending the transmission (e.g., for a TCP transmission).

It should be noted that terms such as “source” and “destination” are used herein to describe various communication devices that may be used in a communication system, and should not be construed to limit the present invention to any particular communication device type. Thus, a communication device may include, without limitation, a bridge, router, bridge-router (brouter), switch, node, client, server, computer, or other communication device.

It should also be noted that terms such as “datagram” and “segment” are used herein to describe communication messages that may be used by a communication device (e.g., created, transmitted, received, stored, or processed by the communication device) or conveyed over a communication medium, and should not be construed to limit the present invention to any particular communication message type, communication message format, or communication protocol. Thus, a communication message may include, without limitation, a frame, packet, datagram, user datagram, cell, or other type of communication message.

The present invention may be embodied in many different forms, including, but in no way limited to, computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof.

Computer program logic implementing all or part of the functionality previously described herein may be embodied in various forms, including, but in no way limited to, a source code form, a computer executable form, and various intermediate forms (e.g., forms generated by an assembler, compiler, linker, or locator). Source code may include a series of computer program instructions implemented in any of various programming languages (e.g., an object code, an assembly language, or a high-level language such as Fortran, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies (e.g., Bluetooth), networking technologies, and internetworking technologies. The computer program may be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL).

Programmable logic may be fixed either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), or other memory device. The programmable logic may be fixed in a signal that is transmittable to a computer using any of various communication technologies, including, but in no way limited to, analog technologies, digital technologies, optical technologies, wireless technologies (e.g., Bluetooth), networking technologies, and internetworking technologies. The programmable logic may be distributed as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

The present invention may be embodied in other specific forms without departing from the true scope of the invention. The described embodiments are to be considered in all respects only as illustrative and not restrictive.

What is claimed is:

1. A method of computing checksums for internet protocol transmissions of transport layer messages, the method comprising:
generating an IPv6 pseudo-header for an IPv4 internet protocol transmission of a transport layer message;
computing a checksum for such transport layer message using the IPv6 pseudo-header; and
storing the computed checksum in a memory for at least one of transmission of transport layer messages and validation of the transport layer messages.

2. A method according to claim 1, wherein the transport layer message is one of a UDP message and a TCP message.

3. A method according to claim 1, wherein generating the IPv6 pseudo-header comprises:
mapping IPv4 information into the IPv6 pseudo-header in such a way that the checksum computed using the IPv6 pseudo-header would match a checksum that would have resulted from use of an IPv4 pseudo-header.

4. A method according to claim 3, wherein mapping includes:
converting a 32-bit IPv4 source address into a 128-bit source address for the IPv6 pseudo-header;
converting a 32-bit IPv4 destination address into a 128-bit destination address for the IPv6 pseudo-header;
converting a 16-bit IPv4 length into a 32-bit length for the IPv6 pseudo-header; and
mapping an IPv4 protocol into a next header for the IPv6 pseudo-header.

5. A method according to claim 4, wherein converting a 32-bit IPv4 address into a 128-bit address comprises:
appending a sequence of 0x00000000000000000000FFFF ahead of the 32-bit IPv4 address to result in a 128-bit address represented by 0x00000000000000000000FFFFXXXXXXXX, where “XXXXXXXX” represents the 32-bit IPv4 address.

6. A method according to claim 4, wherein converting a 16-bit length into a 32-bit length comprises:
appending a sequence of 0x0000 ahead of the 16-bit IPv4 length to result in a 32-bit length represented by 0x0000XXXX, where “XXXX” represents the 16-bit IPv4 length.

7. A method according to claim 1, wherein storing the computed checksum in the memory comprises:
storing the computed checksum in a segment header of the transport layer message.

8. A method according to claim 1, further comprising:
comparing the computed checksum with a received checksum of the transport layer message for validating the received transport layer message.

9. Apparatus for computing checksums for internet protocol transmissions of transport layer messages, the apparatus comprising:
a pseudo-header generator configured to generate IPv6 pseudo-headers for IPv4 internet protocol transmissions of transport layer messages; and
a checksum computer in communication with the pseudo-header generator and configured to compute checksums for such transport layer messages using the IPv6 pseudo-headers for at least one of transmission of transport layer messages and validation of transport layer messages.

10. Apparatus according to claim 9, wherein the transport layer messages include at least one of UDP messages and TCP messages.

11. Apparatus according to claim 9, wherein the pseudo-header generator is configured to map IPv4 information into the IPv6 pseudo-header in such a way that the checksum computed using the IPv6 pseudo-header would match a checksum that would have resulted from use of an IPv4 pseudo-header.

12. Apparatus according to claim 11, wherein the pseudo-header generator is configured to:
convert a 32-bit IPv4 source address into a 128-bit source address for the IPv6 pseudo-header;
convert a 32-bit IPv4 destination address into a 128-bit destination address for the IPv6 pseudo-header;
convert a 16-bit IPv4 length into a 32-bit length for the IPv6 pseudo-header; and
copy an IPv4 protocol into a next header for the IPv6 pseudo-header.

13. Apparatus according to claim 12, wherein the pseudo-header generator is configured to convert a 32-bit IPv4 address into a 128-bit address by appending a sequence of 0x00000000000000000000FFFF ahead of the 32-bit IPv4 address to result in a 128-bit address represented by 0x00000000000000000000FFFFXXXXXXXX, where “XXXXXXXX” represents the 32-bit IPv4 address.

14. Apparatus according to claim 12, wherein the pseudo-header generator is configured to convert a 16-bit length into a 32-bit length by appending a sequence of 0x0000 ahead of the 16-bit IPv4 length to result in a 32-bit length represented by 0x0000XXXX, where “XXXX” represents the 16-bit IPv4 length.

15. Apparatus according to claim 9, wherein the checksum computer is configured to store a computed checksum in a segment header of a transport layer message.

16. Apparatus according to claim 9, wherein the checksum computer is configured to compare a computed checksum with a received checksum of a received transport layer message for validating the received transport layer message.

17. Apparatus according to claim 9, wherein the pseudo-header generator is further configured to generate IPv6 pseudo-headers for IPv6 internet protocol transmissions of transport layer messages, and wherein the checksum computer is further configured to compute checksums for such transport layer messages using the IPv6 pseudo-headers.

18. Apparatus for computing checksums for internet protocol transmissions of transport layer messages, the apparatus comprising:
an IPv4 processor for processing IPv4 internet protocol transmissions, the IPv4 processor configured to generate IPv6 pseudo-headers for IPv4 internet protocol transmissions of transport layer messages;
an IPv6 processor for processing IPv6 internet protocol transmissions, the IPv6 processor configured to generate IPv6 pseudo-headers for IPv6 internet protocol transmissions of transport layer messages; and
a checksum computer in communication with the IPv4 processor and the IPv6 processor and configured to compute checksums for both IPv4 and IPv6 internet protocol transmissions of transport layer messages using IPv6 pseudo-headers for at least one of transmission of transport layer messages and validation of transport layer messages.

19. Apparatus according to claim 19, wherein the transport layer messages include at least one of UDP messages and TCP messages.

20. Apparatus according to claim 19, wherein the IPv4 processor is configured to map IPv4 information into the IPv6 pseudo-header in such a way that the checksum computed using the IPv6 pseudo-header would match a checksum that would have resulted from use of an IPv4 pseudo-header.

21. Apparatus according to claim 20, wherein the IPv4 processor is configured to:
convert a 32-bit IPv4 source address into a 128-bit source address for the IPv6 pseudo-header;
convert a 32-bit IPv4 destination address into a 128-bit destination address for the IPv6 pseudo-header;
convert a 16-bit IPv4 length into a 32-bit length for the IPv6 pseudo-header; and
copy an IPv4 protocol into a next header for the IPv6 pseudo-header.

22. Apparatus according to claim 21, wherein the IPv4 processor is configured to convert a 32-bit IPv4 address into a 128-bit address by appending a sequence of 0x00000000000000000000FFFF ahead of the 32-bit IPv4 address to result in a 128-bit address represented by 0x00000000000000000000FFFFXXXXXXXX, where “XXXXXX” represents the 32-bit IPv4 address.

23. Apparatus according to claim 21, wherein the IPv4 processor is configured to convert a 16-bit length into a 32-bit length by appending a sequence of 0x0000 ahead of the 16-bit IPv4 length to result in a 32-bit length represented by 0x0000XXXX, where “XXXX” represents the 16-bit IPv4 length.

24. Apparatus according to claim 19, wherein the checksum computer is configured to store a computed checksum in a segment header of a transport layer message.

25. Apparatus according to claim 19, wherein the checksum computer is configured to compare a computed checksum with a received checksum of a received transport layer message for validating the received transport layer message.
